(19) United States
(12) Patent Application Publication
(10) Pub. No.: US 2022/0177359 A1
(43) Pub. Date: Jun. 9, 2022

(54) CERAMIC MATERIALS

(71) Applicant: COORSTEK MEMBRANE SCIENCES AS, Oslo (NO)

(72) Inventor: Michael Ian Budd, Sandefjord (NO)

(21) Appl. No.: 17/437,332

(22) PCT Filed: Mar. 11, 2020
(86) PCT No.: PCT/EP2020/056559

§ 371 Date: Sep. 8, 2021

(30) Foreign Application Priority Data
Mar. 11, 2019 (GB) 1903350.5

(51) Int. Cl. C03C 10/00; H01M 8/0226; H01M 8/0215

(52) U.S. Cl. CPC C03C 10/0045; H01M 2300/0068; H01M 8/0215; H01M 8/0226

(57) ABSTRACT

The present invention relates to glass-ceramic/silver composite precursor compositions in the form of powders, and to glass-ceramics/silver composite materials produced therefrom. Such materials find particular use as interconnect materials for high temperature electrochemical conversion devices such as solid oxide fuel cells (SOFCs) and solid oxide electrolysis cells (SOECs).

### FIELD

The present invention relates generally to the field of glass-ceramic/silver composite materials, and in particular to interconnect materials for high temperature electrochemical conversion devices such as solid oxide fuel cells (SOFCs) and solid oxide electrolysis cells (SOECs). It further relates to such devices which incorporate a glass-ceramic/silver composite interconnect material.

### BACKGROUND

Solid oxide fuel cells (SOFCs) are well-known devices which carry out the oxidation of a fuel to produce electricity directly. Solid oxide electrolysis cells (SOECs) are related to SOFCs, but rather than producing electricity via the oxidation of fuels, they use electrical energy to produce hydrogen and oxygen via the electrolysis of steam. The individual cells in SOFC stacks (and SOEC stacks) are connected in series, with each cell separated from the adjacent cells by an electrically conducting interconnect (referred to herein as an “interconnect”). The interconnect is typically a plate-shaped component which provides a gas-tight barrier between the anode of one cell and the cathode of the adjacent cell and which may have channels on either side to assist distribution of the individual gas streams to the appropriate electrodes. The interconnect material should be stable under both oxidising and reducing conditions as it is exposed to the air- and fuel-side gas streams.

Interconnects made from ceramics (i.e. “ceramic interconnects”) as well as those made from metals (i.e. “metallic interconnects”) are known in the art. Interconnects may also be constructed from a mixture of ceramic and metallic materials. As progress has been made in materials, design and cell manufacturing technologies, there has been a general trend for stack operating temperatures to decrease from 900-1000° C. to between 600-750° C. This has allowed much more widespread use of metallic interconnects, which are favoured over ceramic interconnects on the grounds of mechanical robustness, manufacturability, electrical conductivity, and cost, despite their inferior chemical stability and poorer match in thermal expansion with the other cell components. Metallic interconnects are predominantly made from high chromium ferritic alloys, such as Crofer® 22 APU (ThyssenKrupp, Germany) or chromium-based PM alloys such as CFY (Plansee, Austria).

The presence of chromium in the interconnect material is beneficial as it leads to excellent resistance to oxidising atmospheres, but it has a detrimental effect on the long-term performance of the stack. There are two main mechanisms by which chromium in the metallic interconnect causes performance loss in SOFCs. Firstly, a chromia-based oxide scale forms on the air-side of the interconnect. Although thin, this scale causes a marked increase in resistance of the interconnect because the electrical conductivity of the oxide is very low. The scale thickness increases with time at service temperature, so there is a gradual, but continuous decrease in efficiency. Secondly, chromium can easily evaporate from the oxide scale in the form of volatile species such as CrO₂(OH)₂ when exposed to humid oxidising atmospheres. The volatile chromium-containing species are easily transported to the cathode where they are deposited and cause a serious loss of electrode efficiency (cathode poisoning) due to reduction of catalytic activity. There is a gradual reduction in cathode efficiency as the amount of deposited chromium increases during service.

Different approaches have been proposed to minimise or eliminate the problems associated with chromium in SOFCs, SOECs and other high temperature electrochemical reactors.

One approach is to coat the surfaces of chromium containing metallic interconnects. For example, U.S. Pat. No. 5,942,349 proposes a chromium-containing interconnect with a coating on the cathode side. The coating material contains at least one oxide selected from Mn, Fe, Co and Ni, and this reacts with the chromium oxide on the surface of the interconnect to form a protective, chromium-containing spinel layer. U.S. Pat. No. 7,390,582 discloses a protective coating on chromium-containing metallic interconnect materials having the general formula Co_{3-x-y}CuₓMn_{y}O₄ (0<x<1.5, 0<y<3 and x+y<3). A rare earth oxide material is included in the protective coating disclosed in U.S. Pat. No. 8,241,817. U.S. Pat. No. 8,366,972 describes a dual phase protective coating containing a Cu, Ni, Mn, Fe-based spinel phase and a secondary oxide phase containing Mn, Cu and Ni. U.S. Pat. No. 9,452,475 discloses a plasma-sprayed manganese cobalt oxide spinel protective coating on the air-side of an SOFC interconnect. U.S. Pat. No. 9,634,335 describes a composite perovskite/spinel coating of a chromium and iron-containing interconnect material whereby the coating is applied as a powder mixture with a particle size of less than 22 microns.

In general, the aim of the coating on the interconnect is to provide a protective layer which has high electrical conductivity, and which acts a barrier to oxygen diffusion from the surface of the interconnect to the underlying metal in order to reduce the rate of formation of the chromium-rich scale, in addition to providing a barrier to the diffusion of chromium from the metal/scale interface to the surface of the interconnect in order to minimise the rate of chromium evaporation. Rates of performance degradation can be reduced significantly but the associated diffusion/evaporation processes will not be halted completely, so some long-term efficiency loss is inevitable. It has also been reported (Goebel, C. et al (2018) Journal of Power Sources, 383: 110-114) that a Cr₂O₃ layer is always present as an interfacial layer between the coating and the metallic interconnect. Although this layer may be very thin, its extremely low conductivity means that the area specific resistance (ASR) of the interconnect surface can never be reduced below a certain level, irrespective of how high the conductivity of the coating material may be.

In another instance, a chromium getter is employed to trap chromium from the vapour phase to prevent it from poisoning the cathode, as described in U.S. Pat. No. 9,559,366.

Another approach is to use an interconnect which does not contain chromium. For example, U.S. Pat. Nos. 7,396,384 and 7,648,789 describe an SOFC interconnect which has a sandwich structure in which a conductive middle layer is sandwiched between two thin ceramic plates. Each of the ceramic plates has a multitude of small perforations (“vias”) which are filled by the conductive material, thereby ensuring a continuous electrical path from one side of the interconnect to the other. The ceramic material is preferably zirconia, as this provides a good expansion match to other cell components such as a YSZ electrolyte. The ceramic acts as an effective barrier to gas transport and also provides mechanical support to the electrically conductive material. The electrically conductive material is a silver-glass composite which typically contains 15-30 wt % glass. It is specified that the glass phase should be stable against crystallization, preferably having less than 40% by volume crystallization at the temperatures and cool-down rates at which the fuel cell will be used. It is also specified that the glass composition should have only a small variation in viscosity over the service temperature range of the SOFC such that it can flow and act as an effective seal over that range and it should preferably have a high silica content, e.g. 55-80 wt % SiO₂, and a low coefficient of thermal expansion (CTE). An exemplified material contains 80 wt % silver in glass containing Na₂O, K₂O, CaO, BaO, B₂O₃, Al₂O₃ and SiO₂.

An interconnect having a ceramic body containing vias is also described in U.S. Pat. No. 6,183,897. The vias are applied from both anode and cathode side, with the conductive fill material on the anode-side having a similar CTE to the anode material and the conductive fill material on the cathode-side having a similar CTE to the cathode material. The anode-side fill material and the cathode-side fill material are in electrical contact within the thickness of the ceramic body to provide a continuous electrical path from one side of the interconnect to the other. The materials suggested for both the anode-side and cathode-side via fill are metallic materials such as silver-palladium, high chromium alloys and a ceramic material-doped lanthanum chromite.

An SOFC interconnect with off-set vias through a ceramic body of at least two layers is disclosed in US 2005/0227134. The conductive filler may be any suitable electrically conducting material such as strontium doped lanthanum manganite (LSM), strontium doped lanthanum chromite (LSC), or metals such as silver palladium alloys, chromia forming metals and/or platinum. It is suggested that if platinum is used as the electrically conducting material, then it may be combined with other conductive materials, such as silver and palladium alloys and/or with glass, in order to reduce cost.

In all cases where conductive vias are proposed, the total surface cross-sectional area of the conducting material in the vias is only a small fraction of the total area of the interconnect plate. For example, in U.S. Pat. Nos. 7,396,384 and 7,648,789, the total cross-sectional area of the vias is described as being in the range 0.1 to 20 mm² per 1000 mm² of electrode contacting zone (on each side). This represents only 0.01-2.0% of the area of the interconnect plate, leading to severely reduced through-thickness conductivity. In the preferred embodiment described in U.S. Pat. Nos. 7,396,384 and 7,648,789, coverage of the 5400 mm² electrode contacting zone/gas separation area is limited to 19 vias having an average diameter of 300 μm (0.025% coverage, with an average via separation in the range 15-20 mm). With such a sparse via coverage, it is clear that these interconnect plates will need to be used in combination with current-collectors on the electrodes or conductive coatings on the interconnect surfaces.

Another approach using vias is disclosed in U.S. Pat. No. 6,051,330. In this case the interconnect is made from a cermet including partially stabilized zirconia and a super-alloy which is resistant to oxidising and reducing conditions. The metal content is above the percolation limit such that it provides a continuous conductive network from one side of the interconnect to the other. The vias are not filled with conductive material in this case, but are un-filled as their function is to provide improved gas distribution.

An interconnect for an SOFC made from a cermet is disclosed in US 2007/0037031, where the cermet is electrically conductive and ionically non-conductive and, ideally, well matched in CTE with the SOFC electrolyte. It is suggested that the cermet is made from any suitable conducting phase and any suitable ceramic phase. Many potential cermet constituents are postulated but no evidence is presented to show that these can be fabricated and no material property data are disclosed for any cermet composition. In particular, it is not demonstrated that good CTE matching with SOFC cell components can be achieved with the proposed cermet compositions.

U.S. Pat. No. 6,878,651 discloses a glass composition from the BaO—MgO—SiO₂ system which can be used as a glassy matrix phase in composite materials employed in ceramic electrolyte electrochemical conversion devices, primarily for sealing purposes. The glassy matrix phase is mixed with ceramic particles, such as forsterite (Mg₂SiO₄), and it is noted that the mixture can be sealed to YSZ electrolyte at a temperature in the range of 1150-1200° C. It is proposed that metallic particles such as silver or ferritic stainless steel can be mixed with the glassy matrix phase, printed onto electrode surfaces and fired at the sealing temperature to produce a conductive glass-metal coating which can be used as a cell-to-cell interconnector or current collector. However, the technical challenges associated with firing of silver-containing powder mixtures approximately 200° C. above the melting point of silver are not addressed, particularly how de-wetting and segregation of the two phases can be avoided.

There remains a need for alternative composite materials which may be used to form an interconnect suitable for use in an SOFC, SOEC or other high temperature electrochemical conversion device. More specifically, there is a need for such materials having properties which make them particularly suitable for use as interconnect materials in such devices and which may thus be considered to represent an improvement over known composite materials. In particular, there is a need for composite materials which are essentially free from chromium and which may also have other advantageous properties, such as high electrical conductivity and a thermal expansion coefficient which can be tuned to match a wide range of potential ceramic electrolyte materials.

The glass-ceramic/silver composite materials herein disclosed address these needs and provide a class of composite materials which are particularly suitable for use as electrically conducting interconnects in SOFCs, SOECs and other electrochemical conversion devices.

### SUMMARY OF THE INVENTION

The inventor has now discovered that it is possible to produce gas-impermeable, electrically conductive glass-ceramic/silver composites (also referred to herein as “GC/Ag composites”) based on a wide range of alkaline earth silicate and alkaline earth alumino-silicate glass-ceramic systems. As will be described herein, such composite materials have a number of advantages when used as interconnect components in electrochemical conversion devices such as SOFCs and SOECs when compared to currently employed interconnect materials.

In the description of the composite materials, the terms “glass-ceramic/silver composite” and “GC/Ag composite” are used interchangeably herein and are intended to mean a composite which contains a glass-ceramic and either silver or a silver-based alloy. The term “glass-ceramic precursor”, as used herein, is intended to mean a vitreous material which, upon heat-treatment, devitrifies to form a glass-ceramic material.

Viewed from one aspect, the invention provides a chromium-free, glass-ceramic/silver composite precursor composition comprising:

silver-based particles; and

glass-ceramic precursor particles;

wherein said composition comprises 30-70 wt % of said silver-based particles, based on the combined weight of said silver-based particles and said glass-ceramic precursor particles.

In one embodiment the glass-ceramic/silver composite precursor composition may be provided in the form of an intimate mixture or blend of said particles, e.g. in the form of a fine powder.

The glass-ceramic precursor particles can be prepared by a process in which a glass batch is heated to form a homogeneous melt, cooling the same to form a precursor glass (e.g. in the form of a frit), and milling to form fine particles, e.g. a powder. It will be understood that the cooling process is carried out in such a way to avoid devitrification. The particles (e.g. powder) can then be combined with the silver-based particles in order to form the glass-ceramic/silver composite precursor composition.

Viewed from another aspect, the invention provides a chromium-free, glass-ceramic/silver composite comprising:

a silver-based phase; and

one or more crystalline ceramic phases;

wherein said composite comprises 30-70 wt % of said silver-based phase, based on the combined weight of said silver-based phase, said one or more crystalline ceramic phases and any residual glass phase.

Viewed from another aspect the invention provides a method of producing a glass-ceramic/silver composite as described herein, the method comprising the steps of:

heating a glass-ceramic/silver composite precursor composition as described herein (e.g. an intimately mixed blend of glass-ceramic precursor particles and silver-based particles) to a temperature above the glass-transition temperature (T_{g}) of the glass-ceramic precursor composition but below the melting point of the silver-based particles; and

holding the temperature in said range for a duration sufficient to achieve sintering and crystallization of the glass-ceramic precursor composition.

Viewed from another aspect the invention provides a chromium-free, glass-ceramic/silver composite material obtainable or obtained by a method as described herein.

Viewed from another aspect the invention provides an interconnect for use in in a high temperature electrochemical conversion device, wherein said interconnect comprises a glass-ceramic/silver composite as described herein.

Viewed from another aspect the invention provides an electrochemical ceramic membrane reactor comprising at least two cells, the cells each having an anode and a cathode with a gas-tight interconnect between the anode of one cell and the cathode of the adjacent cell, wherein said interconnect is formed from a glass-ceramic/silver composite as described herein.

Viewed from another aspect the invention provides the use of a glass-ceramic/silver composite material as described herein as a gas-tight interconnect in a high temperature electrochemical conversion device, for example in a solid oxide fuel cell (SOFC) or a solid oxide electrolysis cell (SOEC).

The GC/Ag composite materials herein described are essentially free from chromium. This is a significant advantage as potential cell degradation mechanisms which are associated with chromium-containing metallic interconnects (i.e. chromium poisoning of cathodes, and development of low conductivity chromia scale) are minimised, and preferably avoided.

In one embodiment, the CTE of the composite materials herein disclosed can be finely tuned over a wide range by appropriate selection of the glass-ceramic composition and of the silver content. For example, conductive GC/Ag composites herein described may have CTEs in the range 8-15×10⁻⁶ K⁻¹ (25-900° C.), allowing close matching of CTE with a wide variety of potential electrolyte materials. This is not the case with conventional ceramic or metallic interconnect materials, as these have expansion coefficients which are restricted to very narrow, material specific ranges. The ability to tailor the CTE to various cell components enables the levels of residual stress to be reduced considerably during thermal cycling which could potentially lead to greatly improved reliability.

In another embodiment, the GC/Ag composites of the present disclosure have high electrical conductivities. For example, these may be comparable to, and in some cases higher, than the ferritic and chromium-based alloys which are currently favoured in device construction. More importantly, there is no development of an oxide scale on the surface of the GC/Ag composites, so the gradual increase in area specific resistance (ASR) which is seen during service with chromium-containing metallic interconnects is substantially reduced and, preferably, absent altogether.

In another embodiment, the GC/Ag composites herein disclosed have far better electrical performance than via-based interconnects known in the art because the volume fraction of the conducting phase is much higher. For instance, the volume fraction of the conductive silver-based phase in the glass-ceramic/silver composite materials of the invention is typically in the range from 23-40 volume %. In contrast, in the case of laminated, via-based interconnects, the vias are reported to cover no more than 2% of the interconnect surface area. Bearing in mind that the via fill material is a mixture of conductive (silver) and non-conductive (glass) materials, it is thus clear that the volume fraction of conductive phase in the outer (ceramic) layers of the via-based interconnect will be less than 2 volume %. The ASR of a via-based interconnect will therefore be much higher than that of a GC/Ag-based interconnect as herein described. In addition, the conductive phase is finely distributed over the surface of the GC/Ag composites described herein, so it is straightforward to achieve good electrical contact with an adjacent electrode. The situation with via-based interconnects is in stark contrast to this since the vias are small and widely separated on the interconnect surface, making conductive coatings and/or current collectors necessary to achieve adequate electrical contact with the electrode.

In another embodiment, the GC/Ag composites herein disclosed have the advantage of lower density when compared to conventional metallic interconnects. Bulk densities of the GC/Ag composites may lie in the range 4.5-6.2 g/cm³ depending on the glass-ceramic system and the silver content. This compares to reported bulk density values of 7.2 g/cm³ for CFY and 7.7 g/cm³ for ferritic alloys (Crofer/Sanergy). The lower density gives rise to the possibility of making considerable weight savings on SOFC and SOEC stacks which is of particular advantage for non-stationary applications.

In at least certain embodiments, the glass-ceramic/silver composites of the present disclosure have good mechanical strength, high Weibull moduli, and are expected to show relatively high toughness levels due to crack-deflection and energy absorbing processes in the continuous network of silver. As demonstrated herein, measurements carried out on the glass-ceramic materials (without silver) show that these have excellent refractoriness, with dilatometric softening temperatures above 1000° C. The creep resistance at high temperature is therefore expected to be good, due to the mechanical stability imparted by the continuous glass-ceramic framework in the GC/Ag composite materials.

In yet another embodiment, a further advantage of the GC/Ag composites herein disclosed is the ease of component manufacture. The precursor powder mixtures from which these are formed can be processed using a wide range of standard ceramic processing techniques, such as tape casting, pressing, injection moulding, etc., and, unlike the known chromium-based CFY interconnect materials which require a protective atmosphere during manufacture, heat-treatment can simply be carried out in air. This greatly simplifies the manufacturing process and also reduces its cost.

### Terminology

As used herein the term “glass batch” refers to a simple blend of components (e.g. metal oxides, metal carbonates, etc.) which have not undergone melt processing to form a precursor glass.

The glass batch is heated to form a “glass melt” and is subsequently cooled (e.g. by quenching) to form a “precursor glass”. The precursor glass is milled to form a “glass-ceramic precursor” in the form of particles which is combined with silver-based particles to form a “glass-ceramic/silver composite precursor composition” as herein described. The glass-ceramic/silver composite precursor composition may be combined with various additives and formed into a predetermined shape, referred to herein as a “green body”.

Where CTE values are given herein, the value relates to an average CTE value over the specified temperature range.

As used herein, the term “chromium-free” means that the glass-ceramic/silver composite precursor composition or the glass-ceramic/silver composite contain less than 1% by weight chromium, preferably less than 0.1% by weight chromium.

### DESCRIPTION OF FIGURES

FIG. 1 is a schematic diagram of an exploded view of the basic components of an ‘anode supported’ SOFC stack according to an embodiment of the invention showing the arrangement of a cathode (1), an electrolyte (2), an anode (3), and an interconnect (4).

FIG. 2 is a graph showing log (viscosity) versus temperature for pre-sintered precursor glasses 538 and 595 during heating at 3° C./min.

FIG. 3 shows Scanning Electron Micrographs of polished sections of glass-ceramic/silver composite materials (A) GC588/55AgV and (B) GC538/65AgV showing the distribution of the silver (light phase) in the glass-ceramic matrix.

### DETAILED DESCRIPTION OF THE INVENTION

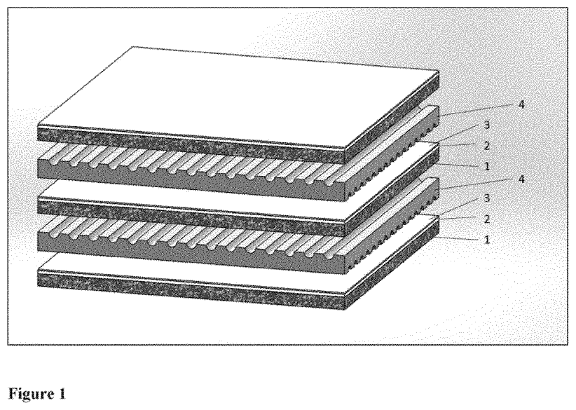

The present invention relates to a glass-ceramic/silver composite material suitable for use as a gas-tight, electrical interconnect in a ceramic membrane reactor, for example in an ‘anode supported’ SOFC stack as depicted in FIG. 1. It further relates to a glass-ceramic/silver composite precursor composition which may be used in the production of such a composite material.

### Glass-Ceramic/Silver Composite Precursor Composition

In one embodiment, the invention relates to a chromium-free, glass-ceramic/silver composite precursor composition comprising:

silver-based particles; and

glass-ceramic precursor particles;

wherein said composition comprises 30-70 wt % of said silver-based particles, based on the combined weight of said silver-based particles and said glass-ceramic precursor particles.

The glass-ceramic/silver composite precursor composition is chromium-free. Typically, the composition contains less than about 1 wt. % chromium, preferably less than about 0.1 wt. %, more preferably less than about 0.05 wt. %. Preferably the composition contains no more than trace levels of chromium and is thus considered “essentially free” from any chromium.

The glass-ceramic/silver composite precursor composition may be prepared by combining glass-ceramic precursor particles and silver-based particles as explained in greater detail below.

Generally, the glass-ceramic/silver composite precursor composition will be provided in the form of a mixture comprising an intimate blend of the silver-based particles and the glass-ceramic precursor particles. Preferably, it will be provided as a free-flowing powder.

### Glass-Ceramic Precursor Particles

Glass-ceramic precursor particles for use as a component of the glass-ceramic/silver composite precursor composition can be prepared via melt processing of a glass batch. The glass batch can be a simple blend of the required metal oxide and non-metal oxides (e.g. as obtained by dry-blending). The nature of these components is not particularly limited, but these should be chosen such that they provide the desired composition of ceramic phase(s) in the final glass-ceramic. After fusing of the glass batch and homogenisation of the resulting melt, the glass melt is cooled to form an amorphous solid, preferably in the form of a frit. The amorphous solid is then comminuted (e.g. by milling) to provide a glass-ceramic precursor powder of a suitable particle size.

In some embodiments, alternative metal compounds which convert to the corresponding metal oxide during melt processing may be used in the glass batch in place of the metal oxide, e.g. metal carbonates, nitrates or phosphates. Where these alternative metal compounds are used, appropriate amounts of the compounds in the glass batch can readily be established based on the desired amount of each metal oxide in the final glass-ceramic precursor composition. In essence, the same molar amounts are required. By way of example, a glass-ceramic precursor composition comprising 25 mol % MgO, 25 mol % CaO and 50 mol % SiO₂ can be prepared from a glass batch comprising 25 mol % MgO, 25 mol % CaCO₃ and 50 mol % SiO₂ (per 100 g of glass: 18.6 g MgO, 46.6 g CaCO₃ and 55.5 g SiO₂).

The use of alternative metal compounds as a precursor to the desired metal oxide can be advantageous since some metal oxides react with moisture or CO₂ in the air over time and thereby change composition which can lead to inaccuracies in weighing appropriate amounts of the metal oxides. Precursor compounds which are more stable during storage than the corresponding metal oxide may be preferred. Suitable precursor compounds include those mentioned above, e.g. metal nitrates, carbonates or phosphates.

It will be appreciated that more complex compounds may also act as a source of the desired metal ions, e.g. magnesium silicate compounds. The skilled person is familiar with the formulation of the glass batch and the variety of compounds that can be used to prepare the glass batch.

The glass batch of metal/non-metal oxides or, more generally, metal/non-metal compounds may be blended as a powder and undergoes a melt processing step. In a melt processing step the glass batch (e.g. oxides and/or non-oxide compounds or perhaps a blend of compounds) is fused to form a homogenous glass melt, e.g. at a temperature above 1200° C., such as 1400-1650° C., preferably 1200 to 1800° C., especially at 1450-1600° C.

Preferably the glass batch is heated in a suitable container such as a platinum crucible to a temperature which is sufficient to produce a homogeneous melt (typically at 1400-1650° C.).

The glass melt is then cooled to room temperature. Ideally, the glass melt is cooled rapidly, preferably by quenching into water to produce a glass frit. Rapid cooling is preferred as this helps to suppress devitrification. The use of water quenching is preferred as the resulting glass frit is readily milled to form a powder. The cooled glass melt, ideally the glass frit, should therefore be amenable to milling to produce the precursor glass powder.

The amorphous solid that forms after cooling is preferably then comminuted, e.g. milled, to produce the glass-ceramic precursor in the form of a powder, preferably a free-flowing powder. The powder preferably has a mean particle size of 1-100 μm (e.g. measured by laser diffraction), such as 2 to 75 μm, e.g. 2 to 50 μm.

Suitable glass-ceramic precursor compositions for use in the invention may be based on a range of alkaline earth silicate and alkaline earth alumina-silicate systems. In one embodiment the glass-ceramic precursor composition includes one or more of the following metal oxides: MgO, CaO, BaO, ZnO, Al₂O₃, La₂O₃, SiO₂, ZrO₂ and P₂O₅.

In certain embodiments, the glass-ceramic precursor composition comprises 35-65 mol % SiO₂. For example, it may include 40-65 mol % SiO₂, such as 40-60 mol % SiO₂.

In certain embodiments, the glass-ceramic precursor composition comprises 5-30 mol % MgO. In other embodiments the MgO content is 10-30 mol %, such as 10-25 mol %. However, the presence of MgO is not essential.

In certain embodiments, the glass-ceramic precursor composition comprises 15-40 mol % CaO. In other embodiments the amount of CaO is 20-40 mol %, such as 20-35 mol %. However, the presence of CaO is not essential.

In certain embodiments, the glass-ceramic precursor composition comprises 5-30 mol % BaO. However, the presence of BaO is not essential.

In certain embodiments, the glass-ceramic precursor composition comprises 5-10 mol % ZnO. However, the presence of ZnO is not essential.

In certain embodiments, the glass-ceramic precursor composition comprises 5-20 mol % Al₂O₃. However, the presence of Al₂O₃ is not essential.

In certain embodiments, the glass-ceramic precursor composition comprises 1-10 mol % La₂O₃. However, the presence of La₂O₃ is not essential.

In certain embodiments, the glass-ceramic precursor composition comprises 1-10 mol % ZrO₂. However, the presence of ZrO₂ is not essential.

The glass-ceramic precursor composition for use in the invention may, for example, have a composition represented by the general formula xAO-yAl₂O₃-zSiO₂ wherein “AO” denotes an alkaline earth oxide or mixture of alkaline earth oxides and x, y and z represent the mol % of AO, Al₂O₃ and SiO₂, respectively. The sum of x, y and z may, but need not, add up to 100 mol %. As will be understood, where x+y+z=100 mol %, the glass-ceramic precursor composition consists of AO, Al₂O₃ and SiO₂ or, where y is 0, only of AO and SiO₂. However, as explained herein, additional components (e.g. B₂O₃, La₂O₃, ZrO₂, etc.) may be present in the composition in which case the sum of x+y+z will be less than 100 mol %. Suitable alkaline earth oxides “AO” which may be present in the composition include MgO, CaO, BaO, SrO, and mixtures thereof. Preferably “AO” will be selected from MgO, CaO, BaO, and mixtures of these oxides.

Preferred examples of suitable glass-ceramic precursor compositions include those having the general formula xAO-yAl₂G₃-zSiO₂, wherein AO represents an alkaline earth oxide or mixture of alkaline earth oxides, x=30-60 mol %; y=0-20 mol %; and z=35-65 mol %. Preferred compositions are those wherein x=35-55 mol %; y=0-15 mol %; and z=40-60 mol %.

In some embodiments the glass-ceramic precursor composition may include B₂O₃ and/or P₂O₅. Whilst the inclusion of low melting point oxides such as B₂O₃ and/or P₂O₅ in the glass composition may be a convenient way of reducing the sintering temperature and improving densification by delaying the onset of crystallization, the level of addition should ideally be limited as B₂O₃ and P₂O₅ can readily form volatile species under typical SOFC and SOEC process conditions which can have a detrimental effect on other components in the electrochemical cells such as electrodes. In addition, these oxides may compromise the high temperature mechanical stability of the glass-ceramic as they can promote the retention of glassy phase during heat-treatment. In an embodiment the glass-ceramic precursor composition comprises 5 mol % or less of B₂O₃, such as 2 mol % or less. In an embodiment the glass-ceramic precursor composition comprises 5 mol % or less of P₂O₅, such as 2 mol % or less.

In some embodiments the glass-ceramic precursor composition comprises 5 mol % or less of alkali metal oxides, such as 2 mol % or less. It may, for example, be substantially free from any alkali metal oxide.

### Formation of Glass-Ceramic/Silver Composite Precursor Composition

The glass-ceramic/silver composite precursor compositions are prepared by mixing the glass-ceramic precursor particles herein described with the silver-based particles. Mixing will generally be carried out with suitable processing aids known in the art such as solvents, binders, dispersants, viscosity regulators, etc. to facilitate the formation of a “green body”.

In a typical procedure the glass-ceramic/silver composite precursor powder, together with any required processing aids, is shaped to form a ‘green body’ of the desired geometry. Suitable methods include those well known in the art, such as tape-casting, pressing, injection moulding, 3-D printing, gel-casting, etc. Organic processing aids such as binders and plasticizers will typically be added prior to shaping to facilitate the shaping operation and impart sufficient green-strength to the shaped part to allow handling. The shaping process may involve pressing in a suitable metal die. Any organic processing aid(s), if added, will burn-off during heating of the shaped preform to the desired heat-treatment temperature.

In some instances, it will be convenient to produce the glass-ceramic/silver composite in the form of a thin tape. In this case, tape-casting may advantageously be employed in the production of the ‘green body’. Where somewhat thicker, planar components are required, lamination of several layers of green tape may be employed to build up the thickness to the required level prior to heat-treatment.

In some embodiments the silver-based particles are silver particles, i.e. particles consisting essentially of silver, or consisting of silver (i.e. pure silver). In other embodiments, however, the silver-based particles are silver-alloy particles, such as silver-palladium alloy particles. Where a silver-alloy is used, the alloying element should not cause depression of the liquidus, and the silver-alloy should include at least 50 wt % silver.

In an embodiment the glass-ceramic/silver composite precursor composition comprises 40-70 wt % silver-based particles based on the combined amount of glass-ceramic precursor particles and silver-based particles. In some embodiments 50-70 wt % silver-based particles may be used. In some embodiments, 45-70 wt %, 45-65 wt % or 45-60 wt % silver-based particles may be used.

In an embodiment the invention provides a chromium-free, glass-ceramic/silver composite precursor composition comprising:

40-70 wt % silver-based particles; and

30-60 wt % glass-ceramic precursor particles;

wherein the wt % are relative to the combined amount of silver-based particles and glass-ceramic precursor particles. Such a composition may be provided in the form of a powder, or a ‘green body’ as herein described.

In an embodiment the invention provides a chromium-free, glass-ceramic/silver composite precursor composition comprising:

40-70 wt % silver-based particles; and

30-60 wt % glass-ceramic precursor particles containing silica (SiO₂) and a combination of two or more oxides selected from the group consisting of: MgO, CaO, BaO, ZnO, Al₂O₃, La₂O₃, ZrO₂ and P₂O₅;

wherein the wt % are relative to the combined amount of silver-based particles and glass-ceramic precursor particles. Such a composition may be in the form of a powder, or ‘green body’ as herein described.

In some embodiments the glass-ceramic precursor particles may consist of SiO₂, metal oxides and non-metal oxides. In some embodiments of the invention the glass-ceramic precursor particles consist of SiO₂ and metal oxides only.

### Preparation of Glass-Ceramic/Silver Composite Materials

The invention provides a method of producing a glass-ceramic/silver composite material, the method comprising the steps of:

heating a glass-ceramic/silver composite precursor composition as described herein to a temperature in the range of above the glass transition temperature (T_{g}) of the glass-ceramic precursor composition and below the melting point of the silver-based particles; and

holding the temperature in said range for a duration sufficient to achieve sintering and crystallization of the glass-ceramic precursor composition.

Initially, as the glass-ceramic/silver composite precursor composition is gradually heated to above the T_{g} of the glass-ceramic precursor composition the material begins to sinter. The glass-ceramic/silver composite precursor composition densifies, primarily by a process of viscous sintering of the glass-ceramic precursor phase as the temperature is increased. The glass-ceramic precursor phase should remain amorphous during sintering—the development of crystalline, ceramic phase(s) occurs during crystallization which should ideally take place after sintering is complete. Sintering typically involves heating to a temperature of 100° C. or more above the T_{g} of the glass-ceramic precursor composition, e.g. to a temperature of at least 800° C., or at least 850° C.

The process as a whole (which includes sintering, then crystallization of the glass-ceramic precursor phase) typically involves heating the glass-ceramic/silver composite precursor composition at a rate of 1 to 20° C. per minute, such as 1 to 10° C. per minute. Firstly, the sintering temperature range is reached, where densification proceeds via the viscous sintering of the glass-ceramic precursor particles. As the temperature is further increased the glass-ceramic precursor phase crystallises. Crystallization typically nucleates at the former surfaces of the glass-ceramic precursor powder particles. The temperature is typically held at a temperature within the crystallization range for a period of time which is sufficient to ensure completion of the crystallization process. A typical period is 1 to 5 hours, but longer or shorter periods may be used

The holding temperature is above T_{g} of the glass-ceramic precursor composition and below the melting point of the silver-based particles. In some embodiments the temperature is held in the range of 900−950° C., such as 925-940° C.

A glass-ceramic/silver composite material is developed on crystallization of the glass-ceramic precursor phase. The resulting glass-ceramic comprises one or more crystalline ceramic phases, and may also contain a small volume fraction (e.g. <10 volume %) of residual glassy phase. After crystallization of the glass-ceramic precursor phase, the resulting glass-ceramic phase has a dilatometric softening temperature in excess of the crystallization temperature, preferably higher than the melting point of the silver-based phase, more preferably above 1000° C.

The invention provides a chromium-free, glass-ceramic/silver composite composition comprising:

a silver-based phase; and

one or more crystalline ceramic phases;

wherein the composition comprises 30-70 wt % of said silver-based phase, based on the combined weight of said silver-based phase, said one or more crystalline ceramic phases and any residual glass phase.

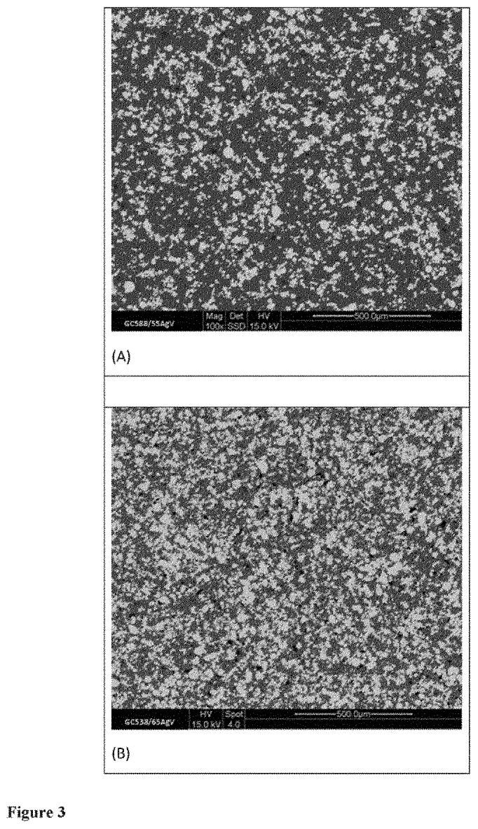

In the glass-ceramic/silver composite material herein described, the silver-based phase and crystalline ceramic phase(s) which form during heat treatment are present as interpenetrating networks within the material. Cross-sections through GC/Ag composite materials showing the distribution of the different phases (in two dimensions) are presented, by way of example only, in FIGS. 3A and 3B. As will be seen, the silver-based material is sufficiently “interconnected” to provide the composite with excellent electrical conductivity throughout the composite material, whereas the crystalline ceramic phase is sufficiently “interconnected” to impart the desired high temperature mechanical strength.

The glass-ceramic/silver composite material herein described is chromium-free. In particular, the material contains less than about 1 wt % chromium, preferably less than about 0.1 wt %, more preferably less than about 0.05 wt %. Preferably the glass-ceramic/silver composite material contains no more than trace amounts of chromium.

In an embodiment, the residual glass content of the glass-ceramic phase is less than 10 volume % of the glass-ceramic/silver composite material, preferably less than 5 volume %. In an embodiment the residual glass content of the glass-ceramic phase is less than 5 vol %, preferably less than 2 vol %.

In an embodiment, the silver-based phase is present in an amount of 20 vol % or more, preferably 25 vol % or more.

The glass-ceramic/silver composite materials may have an electrical conductivity of 1000 S/cm or more at 600° C., preferably 2000 S/cm or more at 600° C., preferably 3000 S/cm or more at 600° C. A suitable range of conductivities at 600° C. is 1000-20000 S/cm, such as 1500-20000 S/cm or 1500-15000 S/cm.

### Uses of the Glass-Ceramic/Silver Composite Materials

The glass-ceramic/silver composite materials described herein find particular application as gas-tight interconnects within a high temperature electrochemical conversion device. For example, these may be used as an interconnect in a fuel cell or in an electrochemical device based on a proton-conducting ceramic membrane. Interconnects must be both mechanically and chemically stable. Unlike other contact layers (e.g. conducting coatings) in electrochemical conversion devices, an interconnect should be capable of providing mechanical support, i.e. it functions as a structural component of the device.

The invention thus provides an interconnect, for example a fuel cell interconnect, comprising the chromium-free, glass-ceramic/silver composite material as defined herein.

An interconnect may be prepared by forming the glass-ceramic/silver composite precursor material (and any required processing aids) into a ‘green body’ having the desired shape, optionally with the aid of compression. The green body is heat treated to achieve crystallization as discussed herein. In contrast to methods used to form other contact layers in electrochemical conversion devices which involve application of a paste to an underlying substrate and firing of the paste in situ to form a thin layer or track on the substrate, an interconnect will generally be formed independently from the other components of the device as a stand-alone component. The interconnect may comprise, consist essentially of, or consist only of the glass-ceramic/silver composite material. It is preferred that the interconnect will be formed only of the glass-ceramic/silver composite herein described.

The interconnect is via-free, i.e. the interconnect does not have pre-formed vias filled with a via-fill material. It will be appreciated by those skilled in the art that the silver phase is not a via-fill material because it is distributed throughout the entire glass-ceramic phase, whereas in an interconnect having vias the via-fill material is only present in selected, defined areas of the ceramic phase.

As will be understood, the size and shape of the interconnect will depend on the configuration of the stack into which it is to be incorporated and those skilled in the art will be able to conceive of suitable structures. Typical interconnects may be plate-shaped for electrochemical devices of planar geometry, and may be of cylindrical/annular shape in the case of electrochemical devices based on tubular geometries. In some cases, an interconnect may contain channels and/or ribs on one or both sides to aid in the efficient distribution of reactants over the fuel side and air side surfaces of the interconnect. This profiling of the surface may be produced via machining of a substantially planar structure, or may be achieved by pressing and sintering of the glass-ceramic/silver composite precursor material in a green body having the desired shape as described herein. An example of a suitable interconnect is illustrated by component (4) in FIG. 1.

In another aspect, the invention provides an electrochemical ceramic membrane reactor comprising at least two cells, the cells each having an anode and a cathode with a gas-tight interconnect between the anode on one cell and the cathode of the adjacent cell, wherein said interconnect is formed from a glass-ceramic/silver composite composition as described herein. The reactor may be a SOFC or SOEC, for example. An illustrative SOFC stack is shown in FIG. 1 which is an exploded view of the basic components of an ‘anode supported’ SOFC stack showing the arrangement of a cathode (1), an electrolyte (2), an anode (3), and an interconnect (4).

In one embodiment, the glass-ceramic/silver composite may provide an interconnect between a first cell and a second cell. The first and second cells may be based on yttria-stabilised zirconia (YSZ) as a solid electrolyte material.

YSZ has a CTE (20-1000° C.) of approximately 10.3×10⁻⁶ K⁻¹. To achieve a good CTE match with YSZ, it is necessary to select a glass-ceramic precursor which will crystallize to form a glass-ceramic having a relatively low thermal expansion. The inventor has established that it is possible to tune the CTE of the glass-ceramic/silver composite material by adjusting the content of the silver-based phase. In general the CTE of the glass-ceramic phase is lower than that of the silver-based phase, so, for a given glass-ceramic composition, the greater the content of silver-based phase the higher the CTE of the glass-ceramic/silver composite. In principle, the lower the CTE of the crystallized glass phase, the more silver-based phase can be added whilst still retaining good CTE matching with YSZ.

The glass-ceramic/silver composite materials described herein also find use as an oxidation resistant, electrical feed-through material in a ceramic body, for example one made from alumina, zirconia toughened alumina (ZTA), or zirconia.

The invention will now be described with reference to the following non-limiting examples.

### Examples

By way of example, a number of electrically conductive glass-ceramic/silver composite materials (“GC/Ag composites”) according to the invention were prepared as set out below. GC/Ag composites with glass-ceramic matrices from a range of different alkaline earth silicate and alkaline earth alumino-silicate systems were made. These were selected to show that the composites can be produced from a diverse range of precursor glass compositions.

### Preparation and Characterisation of Glass-Ceramic Precursors

The compositions of the precursor glasses are presented in Table 1.

TABLE 1

| Precursor | Composition (mol %) | | | | | | | | |
|---|---|---|---|---|---|---|---|---|---|
| Glass No. | MgO | CaO | BaO | ZnO | Al₂O₃ | La₂O₃ | SiO₂ | ZrO₂ | P₂O₅ |
| 498 | — | 33.7 | 8.4 | — | 7.5 | — | 50.4 | — | — |
| 516 | 25 | 25 | — | — | — | — | 45 | 5 | — |
| 538 | 16 | — | 22 | — | — | 5 | 57 | — | — |
| 545 | 22 | 23 | — | — | 9 | — | 46 | — | — |
| 588 | 14 | 28 | — | 3 | 10 | — | 45 | — | — |
| 590 | 20 | 22 | — | — | 11 | — | 45 | — | 2 |
| 595 | 14 | 24 | — | 5 | 12 | — | 45 | — | — |

Glass batches sufficient to yield 800 g of each glass were prepared by mixing high purity raw materials (e.g. magnesium, calcium and barium carbonates, zinc oxide, alumina, quartz, zircon and ammonium dihydrogen phosphate) in the appropriate proportions. The glass batches were melted in a zirconia grain stabilized (ZGS) platinum crucible at temperatures in the range 1450-1600° C. and, once homogenised, each melt was quenched into cold water to form a friable frit. A small bar of glass was also cast from each melt to provide a sample for dilatometric analysis. The glass bars were cast onto a pre-heated steel plate, quickly transferred to an annealing furnace at 750° C. and held at this temperature for 30 minutes. The bar samples were subsequently cooled at 3K/min or less to room temperature.

Precursor glass powders with an average particle size (d₅₀) in the range 20-30 μm were produced by milling the frit in aluminous porcelain mill jars using alumina milling media.

The glass transition temperatures (Tg) of the precursor glasses were measured on the annealed glass bar samples cast from each glass melt. The measurements were performed on 40-50 mm long samples in a horizontal axis dilatometer equipped with an alumina pushrod and sample holder (model 801 L dilatometer, Bahr Thermoanalyse, Hüllhorst, Germany) using a heating rate of 6K/min.

Disc samples were prepared from each of the precursor glass powders for evaluation of viscosity characteristics. Disc samples 8 mm diameter×1.5-2 mm thick were prepared by uniaxial pressing of the individual glass powders in a cylindrical die. A PVA based, temporary binder (Optapix PAF 46, Zschimmer & Schwarz, Lahnstein, Germany) was added to the glass powders to aid pressing and to improve the green strength of the discs. The pressed discs were heated to a temperature which was just sufficient to achieve more or less full densification during a 15 minute dwell. The actual temperature required was determined experimentally by measuring the sintering shrinkage of disc samples which had been subjected to a 15 minute hold at various temperatures. Typically, the temperature required for full sintering in 15 minutes was 90-110° C. above the T_{g} determined from dilatometric measurements on the glass bars.

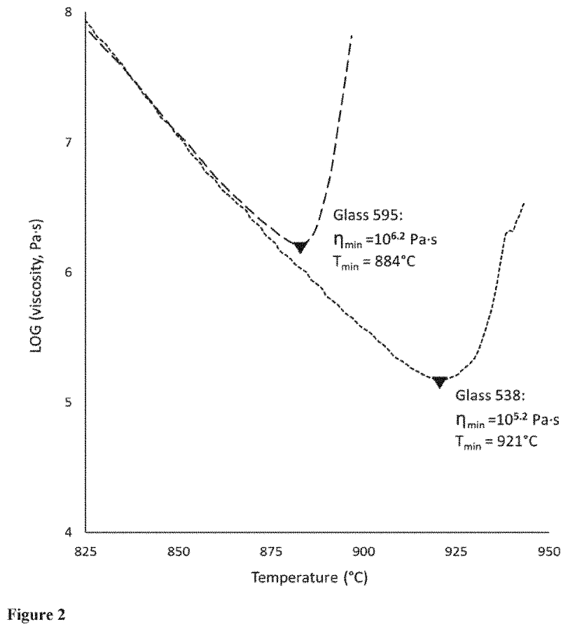

The viscosity of the sintered glass samples was measured at a heating rate of 3K/min in a parallel plate viscometer according to ASTM C1351M-96 (2012). The viscosity was seen to decrease as the sample was heated above the glass transition temperature as would be expected from a vitreous material. However, at some point during the continued heating, the viscosity reached a minimum and was then observed to increase due to the development of crystal phase(s). For illustration, viscosity versus temperature curves for two of the sintered precursor glass powders are shown in FIG. 2. For the precursor glass materials of the present invention, it has been found that a transient minimum viscosity of below approximately 10⁷ Pa s is needed in order to avoid open porosity in the conductive GC/Ag composite after heat-treatment. It is also desirable for the minimum viscosity to occur at a temperature which is below the melting point of the silver or silver alloy used in the GC/Ag composite as this will allow a high degree of crystallization of the precursor glass phase to be achieved within reasonable timescales at the permissible heat-treatment temperatures.

Crystallized samples of the precursor glasses were prepared for determination of thermal expansion characteristics and density. 50 mm diameter discs, approximately 6 mm thick, were produced by uniaxially pressing the precursor glass powders to which 2 wt. % PVA binder had been added. A load of approximately 10 tons was used to press the discs. The green discs were heated to 400° C. at 2K/min in air to burn-out the temporary binder, then at 5K/min to a temperature of 940° C. where they were held for 1 hour. Samples were cooled at 5K/min to room temperature.

Density measurements were performed on the heat-treated discs by the Archimedes method, using water as the immersion medium. Bar samples, 40-45 mm long, were cut from the heat-treated discs for measurement of thermal expansion. The thermal expansion measurements were performed in air on a horizontal axis dilatometer equipped with an alumina pushrod and holder (Bähr model 801L) during heating to a temperature of 1000° C. using a heating rate of 3K/min. Corrections for pushrod/holder expansion were applied using a sapphire reference material measured under the same conditions.

The measured property data for the precursor glasses and their respective glass-ceramics after crystallization are shown in Table 2.

TABLE 2

| | | | | | Density of | Dilatometric |
|---|---|---|---|---|---|---|
| | | | Viscosity | Glass- | sintered | softening |
| Precursor | Glass | Viscosity | minimum | ceramic^{§} | glass- | temperature |
| Glass | T_{g} | minimum* | temperature* | CTE_{25-900° C.} | ceramic^{§} | of glass- |
| No. | (° C.) | (Pa · s) | (° C.) | (10⁻⁶ K⁻¹) | (g/cm³) | ceramic |
| 498 | 770 | 10^{5.6} | 918 | 10.0 | 2.97 | >1000° C. |
| 516 | 760 | 10^{5.2} | 890 | 10.1 | 3.03 | >1000° C. |
| 538 | 750 | 10^{5.2} | 921 | 12.5 | 3.68 | >1000° C. |
| 545 | 740 | 10^{5.8} | 898 | 8.9 | 2.77 | >1000° C. |
| 558 | 760 | 10^{5.4} | 869 | 9.2 | 3.11 | >1000° C. |
| 588 | 740 | 10^{5.6} | 906 | 7.7 | 2.87 | >1000° C. |
| 590 | 750 | 10^{5.7} | 911 | 7.5 | 2.70 | >1000° C. |
| 595 | 740 | 10^{6.2} | 884 | 7.3 | 2.83 | >1000° C. |

*During heating of vitreous, sintered powder compact at 3K/min
^{§}Crystallization heat-treatment 940° C./1 h

### Preparation of Glass-Ceramic/Silver Composites

Glass-ceramic/silver composites were produced by heat-treatment of intimate mixtures of the glass-ceramic precursor powders and silver powders. The silver powders which were used were grades AGP-V0180-4 and AGP-H3150-9 (C50) from Doduco Contacts and Refining GmbH, Pforzheim, Germany. Their mean particle sizes (d₅₀) were in the range 15-35 μm and 4-15 μm, respectively (manufacturer's data).

Powder mixes containing 35-47.5 wt % glass-ceramic precursor and 65-52.5 wt % silver were made up from the various glass-ceramic precursor powders and the silver powders. The glass-ceramic precursor and silver powders were initially thoroughly dry mixed, then a binder (Optapix PAF 46, Zschimmer & Schwarz, Lahnstein, Germany) was blended in to produce a thick paste. After drying, the paste was crushed and sieved to yield a powder which was suitable for pressing. 50 mm diameter×5 mm thick discs were uniaxially pressed (10 tons) to provide samples for thermal expansion measurement; 20 mm diameter×2 mm thick discs were pressed (2 tons) to provide samples for determination of electrical conductivity; and 20 mm diameter×1.6 mm thick discs were pressed (4 tons) from selected materials to provide samples for measurement of mechanical strength. Heat-treatment of the discs involved heating in air to 400° C. at 1.5 K/min in a muffle furnace for binder burn-out, and thereafter at 5K/min to a holding temperature in the range 925-940° C. (holding time 1-2 hours).

Bar samples approximately 45 mm×4 mm×5 mm were cut from the larger discs for CTE measurement. The thermal expansion measurements were performed in air on a horizontal axis dilatometer equipped with an alumina pushrod and holder (Bahr model 801L). Measurements were performed in air during heating (3K/min) to 900° C. and during cooling (−3K/min or slower) to 40° C. Corrections for pushrod/holder expansion were applied using a sapphire reference material measured under the same conditions.

The flat surfaces of the conductivity samples were lightly dressed by rubbing with a 400 grit (37 μm) diamond pad prior to undertaking the measurements. Sample dimensions were approximately 18 mm diameter×1.8 mm thick. The conductivity measurements were performed at 50° C. intervals over the temperature range 300-800° C. in air using a standard 4-point probe method (Van der Pauw technique).

Mechanical strength measurements were performed at the National Physical Laboratory (NPL), Teddington, UK on selected GC/Ag composite materials. The strength was measured in biaxial flexure on a sample of 20 test-pieces of each of the selected materials. The test-pieces were discs of approximately 18.5 mm in diameter×1.5 mm thick. The faces of the discs were lightly dressed by rubbing with a 400 grit (37 μm) diamond pad to remove any surface protrusions which may have resulted from the pressing or sintering processes. A ring-on-ring test jig (16 mm/6 mm diameter) was used at a cross-head displacement rate of 0.2 mm/min.

Density measurements were performed by the Archimedes technique using water as the immersion medium. The volume fraction of silver in each of the composites was calculated from the silver weight percentage and the measured density. The porosity of the composites was calculated from the previously measured densities of the glass-ceramic matrix materials and the measured GC/Ag composite density. The calculated porosity therefore excludes any closed porosity which may have been present in the glass-ceramic matrix samples.

Composition and heat-treatment details of the GC/Ag composites are set out in Table 3. Table 4 summarises the results of the density, thermal expansion and electrical conductivity measurements on the GC/Ag composite materials. The results of mechanical strength measurements on selected materials are presented in Table 5.

TABLE 3

| Material | Precursor | | wt. % | Heat- |
|---|---|---|---|---|
| reference | glass | Silver powder | silver | treatment |
| GC498/60AgV | 498 | AGP-V0180-4 | 60 | 930° C./2 h |
| GC516/55AgV | 516 | AGP-V0180-4 | 55 | 930° C./2 h |
| GC538/65AgV | 538 | AGP-V0180-4 | 65 | 940° C./1 h |
| GC545/60AgC | 545 | AGP-H3150-9 | 60 | 940° C./1 h |
| | | (C50) | | |
| GC545/60AgV | 545 | AGP-V0180-4 | 60 | 940° C./1 h |
| GC588/55AgV | 588 | AGP-V0180-4 | 55 | 940° C./1 h |
| GC588/60AgV | 588 | AGP-V0180-4 | 60 | 940° C./1 h |
| GC588/60AgC | 588 | AGP-H3150-9 | 60 | 940° C./1 h |
| | | (C50) | | |
| GC588/65AgV | 588 | AGP-V0180-4 | 65 | 930° C./2 h |
| GC590/55AgV | 590 | AGP-V0180-4 | 55 | 925° C./1 h |
| GC595/52.5AgV | 595 | AGP-V0180-4 | 52.5 | 930° C./2 h |
| GC595/55AgV | 595 | AGP-V0180-4 | 55 | 930° C./2 h |
| GC595/60AgV | 595 | AGP-V0180-4 | 60 | 930° C./2 h |
| GC595/65AgV | 595 | AGP-V0180-4 | 65 | 930° C./2 h |

TABLE 4

| Material | Density | Vol % | | CTE_{25-900°C.} | Conductivity (S/cm) | | |
|---|---|---|---|---|---|---|---|
| reference | (g/cm³) | silver | Porosity | (10⁻⁶ K⁻¹) | 400° C. | 600° C. | 800° C. |
| GC498/60AgV | 5.18 | 29.6 | 0.6% | 11.0 | 6290 | 4650 | 3830 |
| GC516/55AgV | 4.65 | 24.3 | 5.2% | 11.1 | 2810 | 2120 | 1690 |
| GC538/65AgV | 6.14 | 38.0 | 3.4% | 14.8 | 22290 | 16260 | 13220 |
| GC545/60AgC | 4.73 | 27.0 | 4.7% | 10.4 | 13080 | 9770 | 7720 |
| GC545/60AgV | 4.79 | 27.4 | 3.5% | 10.2 | 6510 | 4910 | 4130 |
| GC588/55AgV | 4.56 | 23.9 | 4.6% | 9.1 | 3780 | 2850 | 2290 |
| GC588/60AgV | 4.84 | 27.7 | 4.9% | 9.8 | 6930 | 5340 | 4250 |
| GC588/60AgC | 4.78 | 27.3 | 6.1% | 10.1 | 8060 | 6040 | 4800 |
| GC588/65AgV | 5.17 | 32.0 | 4.9% | 10.3 | 16060 | 12070 | 9600 |
| GC590/55AgV | 4.49 | 23.5 | 2.5% | 9.3 | 4470 | 3310 | ND |
| GC595/52.5AgV | 4.43 | 22.2 | 3.5% | 8.6 | 3010 | 2230 | 1760 |
| GC595/55AgV | 4.57 | 23.9 | 3.4% | 8.8 | 5220 | 3790 | 3050 |
| GC595/60AgV | 4.80 | 27.4 | 4.7% | 9.3 | 7610 | 5710 | 4580 |
| GC595/65AgV | 5.11 | 31.7 | 5.2% | 9.6 | 15900 | 11990 | ND |

ND = not determined

Table 4 shows that GC/Ag composites with high electrical conductivities can be produced with CTEs (25-900° C.) covering the range 8 to 15×10⁻⁶ K⁻¹. This offers a major advantage in the application area of interconnect materials since it enables the CTE to be tuned to match various cell components, for example in SOFCs and SOECs.

TABLE 5

| | Biaxial flexural strength | | |
|---|---|---|---|
| Material | Average strength | Std. Dev. | Weibull |
| reference | (MPa) | (MPa) | modulus |
| GC545/60C | 164 | 8.5 | 23.0 |
| GC588/65V | 133 | 6.2 | 25.8 |

Table 5 shows that the selected GC/Ag composites have good mechanical strengths. More importantly, the strength is extremely uniform, characterised by an exceptionally high Weibull modulus in each case. This indicates that the materials have excellent flaw tolerance and can be expected to have high reliability in service. In the case of the GC588/65V composite, significant inelastic behaviour was observed before peak load was reached.

1. A chromium-free, glass-ceramic/silver composite precursor composition comprising:
silver-based particles; and
glass-ceramic precursor particles formed from a material having the general formula xAO-yAl₂O₃-zSiO₂ in which AO represents an alkaline earth oxide or mixture of alkaline earth oxides and x, y and z represent the mol % of AO, Al₂O₃ and SiO₂, respectively, and in which x=30-60 mol %, y=0-20 mol %, and z=35-65 mol %;
wherein said composition comprises 30-70 wt % of said silver-based particles, based on the combined weight of said silver-based particles and said glass-ceramic precursor particles.

2. A composition as claimed in claim 1 in the form of a powder.

3. A composition as claimed in claim 1 or claim 2, wherein x=35-55 mol %; y=0-15 mol %; and z=40-60 mol %.

4. A composition as claimed in any one of claims 1 to 3, wherein said glass-ceramic precursor particles contain one or more of the following metal oxides: MgO, CaO, BaO, SrO, ZnO, La₂O₃, ZrG₂ and P₂O₅, or mixtures thereof.

5. A composition as claimed in any one of claims 1 to 4 which comprises 40-70 wt % silver-based particles, such as 50-70 wt % silver-based particles.

6. A composition as claimed in any one of claims 1 to 5, wherein said silver-based particles are silver particles.

7. A composition as claimed in any one of claims 1 to 6, wherein said silver-based particles are silver-alloy particles, such as silver-palladium alloy particles.

8. A composition as claimed claim 7, wherein said silver-alloy particles comprise at least 50 wt % silver.

9. A composition as claimed in any one of claims 1 to 8, wherein said glass-ceramic precursor particles contain 5 mol % or less of B₂O₃, such as 2 mol % or less.

10. A composition as claimed in any one of claims 1 to 9, wherein said glass-ceramic precursor particles contain 5 mol % or less of P₂O₅, such as 2 mol % or less.

11. A chromium-free, glass-ceramic/silver composite comprising:
a silver-based phase; and
one or more crystalline ceramic phases formed from a material having the general formula xAO-yAl₂O₃-zSiO₂ in which AO represents an alkaline earth oxide or mixture of alkaline earth oxides and x, y and z represent the mol % of AO, Al₂O₃ and SiO₂, respectively, and in which x=30-60 mol %, y=0-20 mol %, and z=35-65 mol %;
wherein said composite comprises 30-70 wt % of said silver-based phase, based on the combined weight of said silver-based phase, said one or more crystalline ceramic phases and any residual glass phase.

12. A composite material as claimed in claim 11, wherein said material comprises 40-70 wt % of said silver-based phase, such as 50-70 wt % of said silver-based phase.

13. A composite material as claimed in claim 11 or claim 12, wherein the one or more glass-ceramic phases in said material contain less than 10 volume % residual glass phase, preferably less than 5 volume % residual glass phase, preferably less than 2 vol % residual glass phase.

14. A composite material as claimed in any one or claims 11 to 13, wherein said silver-based phase is present in an amount of 20 vol % or more of said composite material, preferably 25 vol % or more.

15. A composite material as claimed in any one of claims 11 to 14, wherein said silver-based phase is a silver phase.

16. A composite material as claimed in any one of claims 11 to 15, wherein said silver-based phase is a silver-alloy phase, such as a silver-palladium alloy phase.

17. A method of producing a chromium-free, glass-ceramic/silver composite as defined in any one of claims 11 to 16, the method comprising the steps of:
heating a chromium-free, glass-ceramic/silver composite precursor composition as claimed in any one of claims 1 to 10 to a temperature above the glass-transition temperature (T_{g}) of the glass-ceramic precursor particles but below the melting point of the silver-based particles; and
holding the temperature in said range for a duration sufficient to achieve sintering and crystallization of the glass-ceramic precursor particles.

18. A method as claimed in claim 17, wherein during crystallization the temperature is held in the range of 900-950° C., such as 925-940° C.

19. A chromium-free, glass-ceramic/silver composite material obtainable or obtained by a method as claimed in claim 17 or claim 18.

20. An interconnect for use in a high temperature electrochemical conversion device, wherein said interconnect comprises a glass-ceramic/silver composite material as claimed in any one of claims 11 to 16 and 19.

21. An electrochemical ceramic membrane reactor comprising at least two cells, the cells each having an anode and a cathode with a gas-tight interconnect between the anode of one cell and the cathode of the adjacent cell, wherein said interconnect is formed from a glass-ceramic/silver composite as claimed in any one of claims 11 to 16 and 19.

22. An electrochemical ceramic membrane reactor as claimed in claim 21 which is a solid oxide fuel cell (SOFC) or solid oxide electrolysis cell (SOEC).

23. Use of a chromium-free, glass-ceramic/silver composite material as claimed in any one of claims 11 to 16 and 19 as a gas-tight interconnect in a high temperature electrochemical conversion device, such as a SOFC or SOEC.
